(19) United States
(12) Patent Application Publication
(10) Pub. No.: US 2005/0108644 A1
(43) Pub. Date: May 19, 2005

(54) Media diary incorporating media and timeline views

(75) Inventors: Andrea Finke-Anlauff, Braunschweig (DE); Andreas Myka, Helsinki (FI); Laura Huhtela-Bremer, Espoo (FI); Younghee Jung, Helsinki (FI); Olof Schybergson, London (GB); Vesa Metsatahti, Helsinki (FI); Annika Macke, Braunschweig (DE); Tomi Hakari, Sipoo (FI); Christian Lindholm, Helsinki (FI); Olli Oksanen, Helsinki (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/792,175

(22) Filed: Mar. 3, 2004

Related U.S. Application Data
(63) Continuation of application No. 10/715,187, filed on Nov. 17, 2003.

(51) Int. Cl. G11B 27/00

(52) U.S. Cl. 715/721

(57) ABSTRACT

A media diary application implemented in a digital communication device. The media diary provides for a media view that present media files associated with a period of time and a timeline view that provides access to the media files according to periods of time in the timeline.

### CROSS-REFERENCE TO RELATED APPLICATIONS

This application is a continuation of U.S. patent application Ser. No. 10/715,187, filed Nov. 17, 2003.

### FIELD OF THE INVENTION

The present invention relates to digital communication and, more specifically, to an application for providing digital communication devices with a media diary that associates digital media files periods of time, moments in time or events.

### BACKGROUND OF THE INVENTION

The rapid growth of digital communication has made it possible for all kinds of digital media files to be communicated amongst various types of wireless and wire line communication devices. For instance, the cellular or mobile telephone is no longer limited to telephonic voice communication and may include other means of digital communication, such as digital networking (i.e., Internet communication, text messaging, and the like). In addition, an increasing number of cellular telephones and other mobile wireless communication devices, such as portable computers, personal data assistants (PDAs) and the like, are being integrated with other means of capturing or producing digital media, such as digital cameras, digital audio recorders, digital video recorders and the like. Technological advances have made it possible for other digital devices, such as digital cameras, digital video recorders, digital audio devices and the like to be equipped with means for digital communication. As more and more digital devices possess the capability to digitally communicate with one another, the amount of digital media files that will be communicated amongst these devices will increase at an alarming rate.

In addition to the onset of more and more digital devices possessing digital communication capabilities, the digital storage capacity of these devices is constantly increasing. In the near future the majority of mobile digital communication terminals may well be equipped with storage capacity in the gigabyte range or greater, allowing these devices to store an enormous amount of digital data. In this environment it will no longer be prohibitive from a memory capacity standpoint to store a voluminous amount of large file types, such as video, audio or other multimedia files.

In the digital communication environment where more and more digital devices, both wireless and wired, are equipped with a means for digital communication and where the storage capacity of these devices has become seemingly endless, the digital communication device will encounter and store innumerable digital media files. As such, the digital communication device will desire a means to access, store, manage and further communicate these digital files in an efficient and user-friendly environment.

For example, if a digital communication device receives a digital media file the user of the device would benefit greatly from an application that automatically places the file into a readily accessible storage area and where managing and accessing of the file in the future can occur efficiently, without the user having to spend a great deal of time searching for the media file.

Most digital media files can be readily categorized and stored according to a period of time, moment in time or event. For example, a wedding video can be categorized according to the date of the wedding and photographs taken at a party can be categorized according to the date of the party. These are examples of categorizing the media file based on the creation date of the media file. In other instances the media file can be associated with the date on which the media file is used or presented or the date on which the recipient receives the file. For example, a multimedia presentation for a business meeting may be categorized according to the date of the presentation and a personal text file from a friend may be categorized according to the date received.

Therefore, the need exists to develop a media file organizing application for a digital communication device. In order to provide the necessary organization to the user, the media file organizing application should be capable of automatically entering received media files into the application and automatically or manually associating the media files with a specific period of time, moment in time or event. In order to provide the necessary efficiency to the user, the application should be highly searchable so that media files can be readily accessed by the user. In addition, a desired media file organizing application will possess the capability to easily further disseminate the media files to other digital communication devices.

### BRIEF SUMMARY OF THE INVENTION

The present invention provides for a media diary application implemented in a digital communication device. The media diary provides for a digital media file manager that organizes media by timeframe. The media diary provides for a media view of media files associated with a period of time, a moment of time or an event. The media diary also provides for a timeline view that is presented in combination with the media view and associates the media files with periods of time defined in the timeline.

In one embodiment of the invention, an application for representing media files on a digital device display is defined. The application comprises a computer readable storage medium having computer-readable program instructions embodied in the medium. The computer-readable program instructions includes first instructions for generating a media view that provides access to digital media files and associates digital media files with a moment or period of time or an event and second instructions for generating a timeline view that is presented in combination with the media view and associates the media files according to periods of time in the timeline.

Additional application features may be provided by the instructions. For example, the first instructions may associate digital media files with a period of time based upon information associated with the digital media file, such as metadata. The first instructions may operate to create and display a title for a group of media files, with the grouping and/or title being based on similar metadata information. The group may be created automatically by the media diary application or by at the request of the user.

The invention is additionally embodied in various methods for digital media management in a digital device. One method includes the steps of receiving, at the digital device, a digital media file having metadata associated with the digital media file, transmitting the file to a media diary application that associates the digital media file with a period in time based on the metadata and providing a user access to the digital media file via a media view that displays a representation of the digital media file in connection with the period of time. The file may be automatically transmitted to the media diary application upon receipt, such that the user of the diary does not need to manually import the files from other applications. The user is provided access to the media files via a media view in the media diary that associates the file with a period of time. Additionally, the user may be provided with a timeline view within the media diary that combines a timeline with the media view.

The invention defines a further method for defining media file representation in a media view of a media diary application. The method includes the steps of receiving a media file having associated metadata information, determining the manner in which the media file will be represented in a media view of the media diary, and presenting the media file as a media file representation in the media view in accordance with the correlation procedure and the determination of the manner of representation. Determining the manner in which the media file will be represented in a media view may entail determining the representation icon, determining the size of the date column within the media view and/or determining the size of the media view in the overall media diary layout.

A further embodiment of the invention is defined by a digital device having a processing unit that executes computer-readable program instructions for accessing media files. The computer-readable program instructions include first instructions for generating a media view that provides access to digital media files and associates digital media files with a period of time and second instructions for generating a timeline view that is presented in combination with the media view and provides access to the at least one digital media file according to periods of time defined in the timeline. Additionally, the digital device will include a display in communication with the processing unit that presents the user access to media files through the media view and the timeline view.

Thus, the present invention provides a useful tool in managing media files in a digital device. The media diary will store files by associating the files with an event or a period of time and provide the user with access to a media view that displays the files in association with the event or period of time. The scrollable nature of the timeline view provides the user with ready access to the stored media files. With more and more digital devices either having the capability to create media files or communicate media files and the storage capacity of such devices increasing dramatically, the present invention addresses the need that exists for a media management application that will provide the user with easy access to an unlimited number of media files.

### BRIEF DESCRIPTION OF THE DRAWINGS

Having thus described the invention in general terms, reference will now be made to the accompanying drawings, which are not necessarily drawn to scale, and wherein:

FIG. 1 is an illustration of a media view or media window as displayed by the media diary, in accordance with an embodiment of the present invention.

FIG. 2 is an illustration of a timeline view in combination with a media view, in accordance with an embodiment of the present invention.

FIG. 3 is a block diagram of a digital device implementing a media diary, in accordance with an embodiment of the present invention.

FIG. 4 is a flow diagram of a method for digital media management in a digital device, in accordance with an embodiment of the present invention.

FIG. 5 is a flow diagram of a method for defining digital media file representation in a media view of a media diary, in accordance with an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention provides for a media diary application implemented in an electronic device, such as a digital communication device. The media diary organizes digital media files by period of time, moment of time or event. For the sake of brevity and clarity, the invention defines “period of time” to include both moment of time and an event associated with a period of time. The media diary provides for a media view of media files associated with an event, a date or another period of time. The media diary may also provide for a timeline view that is presented in combination with the media view and provides access to the digital media files according to periods of time defined in a timeline, herein the timeline is also referred to as a time bar.

In one embodiment the media view will present media files associated with a past moment of time, such as year, month, week, day, hour, a specific time, or period of time. The association process may involve associating the media file with a period of time based on media file metadata, such as a timestamp or the like

The media diary application of the present invention may be implemented and executed on any electronic device that incorporates a display, such as a desktop or portable computer, cellular telephone, personal data assistant (PDA), digital camera, digital camcorder, e-book device, television, digital audio player or the like. In addition the media diary application may be implemented on electronic devices that are connected to an external display, such as a set-top box (STB), personal video recorder (PVR), digital video recorder (DVR) or the like. While in most implementations the digital device that executes the media diary application will be capable of any type of wireless or wireline network communication, such as wireless telecom, short range radio network, Bluetooth®, Wireless Local Area Network (WLAN), Radio Frequency Identification (RFID), Internet Protocol Data Casting (IPDC), Digital Video Broadcasting (DVB), Infrared Data Association (IrDa), Internet or the like, it is not required that the digital device be adapted to communicate via network. Devices that are capable of requiring digital media files internally or may access media files through memory devices (e.g., flash storage device, memory sticks, video and audio storage tapes, CD, DVD, removable hard disc device (HDD) and the like) are also applicable.

In accordance with an embodiment of the present invention, the media diary application will be embodied by a computer-readable storage medium having computer-readable program instructions stored in the medium. The storage medium will typically be a memory device, such as flash ROM memory, HDD or the like. The programming instructions may be written in a standard computer programming language, such as C++, Java or the like. Upon execution by a processing unit as described below, the program instructions will implement the various functions of the media diary application as described below. The computer-readable program instructions include first instructions that will generate a media view that provides access to digital media files and associates digital media files with time information, such as a moment or period of time and second instructions for generating a timeline view that is presented in combination with the media view and provides access to the media files according to the periods of time defined in the timeline. While the first and second instructions may be modules, objects or the like that communicate with one another, the first and second instructions need not be discrete or separable portions of the program instructions and may be interspersed throughout if so desired.

Typically, the media diary of the present invention will be an individual media diary associated with the user of the device. This is particularly the case when the device that implements the diary is typically personal in nature, such as a cellular telephone, PDA or the like. However, the media diary of the present invention may also provide for a multiple-user media diary, in which, the diary is set-up for multiple users to access the diary, typically with access controlled by individual user identification and passwords. For example, a media diary may be a family media diary implemented on a home computer or on a server in a network environment with each member of the family having individual access. In the multiple-user mode, certain media file content may be generic amongst all users, while other media files may be designated as user-specific. The multiple-user embodiments are typically associated with implementation on general, non-user specific devices, such as a home computer, digital camera or digital camcorder. In addition, a multiple user embodiment may be defined by a media diary that is implemented on a public server, e.g., Internet server, and users having Internet or some network-based access to the common media diary application. In this instance certain media files may be designated as common to all of the users of the application and other information may be designated as user specific information.

In accordance with another aspect of the present invention, media diary or any portion of the media diary, such as the media view or the like may be synchronized with other media diary applications, calendar, personal planner or media presentation applications. The other media diary applications may be implemented on the same device as the original media diary application or they may be implemented on other devices. In this regard, the media diary application can import, either automatically or manually, media content, calendar events or reminders from other media diary, calendar or media presentation applications. Synchronization of the media content and/or calendar event information between remote devices may be accomplished by any known wireless or wired network communication technique, such as wireless telecom, short range radio network, Bluetooth®, WLAN, RFID, IPDC, DVB, IrDA, Internet or the like.

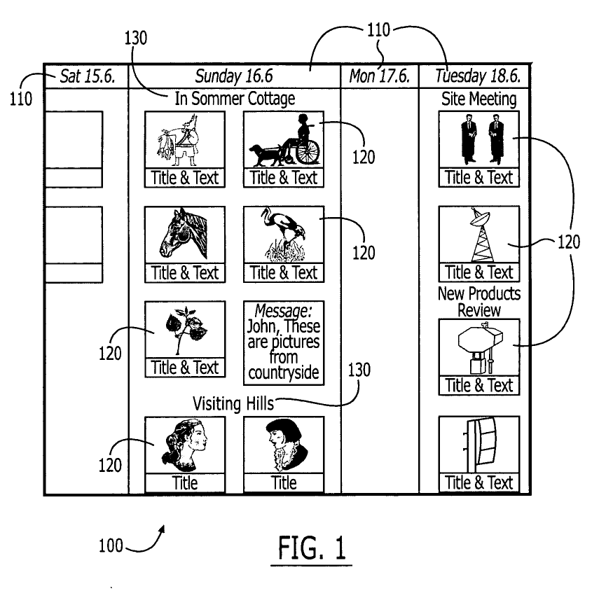

FIG. 1 illustrates an example of a media view 100 that provides for digital media files, such as digital images, digital video, digital audio, computer games, computer software, digital text files or the like, to be accessible to the media diary user, in accordance with an embodiment of the present invention. Typically the media files that are represented in the media view will be associated with period of time, moment in time or an event. The media view will be generated by first computer-readable program instructions implemented in association with a digital device. It is noted that the media view herein depicted and described is by way of example only; other media views that provide for the display of media file representations in association with a moment of time, a time period or an event are also contemplated and within the inventive concepts herein disclosed. Alternatively, the media files that are represented in the media view may be associated with a moment or period of time based on a timestamp in the media file, without having noted an event related to the media file.

The media view of the illustrated embodiment includes date columns 110, which correspond to a specific date, although the media view may be differently oriented if so desired. In the example shown, four date columns are visible on the display corresponding to the four previous dates. In an alternate embodiment the media view may include columns 110, which may correspond to any moment of time, such as a year, a month, a week, a day, an hour or the like. The date columns may include both past dates, present dates and future dates. While most media files will be categorized in past date columns it is possible for media events to be categorized and displayed in future date columns. For example, a yet-to-be presented multi-media presentation can be categorized under a future date column.

The date columns will include media file representations 120 that are related to media files and are connected, in time, to the specific date, event and/or time. For example, the media file representations may include representations that provide the user with access to digital files, such as video files, image files, audio files, text files, emails, short message service (SMS) messages, multimedia message service (MMS) messages and the like and provide the user with information pertaining to the content of the files. The media file representations may include an icon, or a thumbnail image, a portion of the text of a text document or message or any other suitable media file representation with or without a title of the media file. The media files will typically be stored in a memory unit that is either located within the device that implements the media diary or is in communication with the device that implements the media diary. In instances in which the media files are stored within a memory unit located on the digital device implementing the media diary, the memory unit may be the same entity that stores the media diary operating instructions.

The form and style of the media file representations 120 may by user's preference or the form style may be automatically determined by the media diary application. I addition, the presentation and categorization of media file representations may be by user's preference or automatically determined by the media diary application.

Typically, the media diary will receive the media file from a digital recording function associated with the device or via digital communication from other devices. For example:
1) If the digital device is a cellular telephone that incorporates a digital camera or any other digital device that serves as a digital recording device, a digital media file (i.e., image) may be communicated directly via cellular telephone access from the camera/telephone device to the media diary in another device.
2) If the digital device is an independent digital camera or any other digital recording/storing/playing device and equipped with a wireless or wireline network connection the digital media file may be communicated directly from networked device to a media diary in another device.
3) If the digital device is an independent digital camera or any other digital recording/storing/playing device and equipped with short range digital communication means the digital media file may communicated first to a long range digital communication device (i.e. cellular telephone, a PDA, laptop or the like) that then passes the files to another device with a media diary. Alternatively, in proximity, a file transfer may occur directly to another device with a media diary.
4) The media files may be communicated by a physical memory unit/device transferred from one device to another device.

As such, the digital recording/storing/playing device from which the media file is communicated (i.e., the passing device) may include, and implement, the media diary application or may not include the media diary application. If the passing device includes the media diary application, the media files may be processed for media diary purposes prior to communication to other devices.

The communication /synchronization of the media files may be automatic after a creation of a new media file, or after a certain amount of media files have been created. Alternatively, the communication may occur at a selected time or on a request of a user and may include a single media file or a group of media files. Alternatively, the communication may occur at a specific location and/or via a specific network connection, e.g., at home via a Bluetooth connection. The communication/synchronization may occur via any wireless or wireline network communication method, such as for example via SMS, MMS or file transfer. The communication, i.e. synchronization, may also occur from a back end media diary application/device to any digital recording/storing/playing device with or without the media diary application.

The media file will typically have associated metadata, in the form of a timestamp, event name, file name, location information, people in the event or in the media file, objects in the media file, file type, file size, temperature, weather conditions or any other information. Additionally, the metadata may include information from any sensors installed in a media capturing, a media diary or any external device in communication to the media capturing or the media diary device. The media file metadata may be automatically inputted by the digital recording device at the time of the creation of the media file or may be manually inputted, such as at the time of creation of the media file or receipt or transfer of the media file.

Additionally, media files forming or related to a specific joint group, e.g. based on a specific event, time period or any other metadata, may be placed in the media view in a joint group 130 under a common title or subject. The media files within the joint group may be bordered, shaded, colored or otherwise graphically indicated to designate the media files as being within the joint group. The title or subject may be manually inputted or may be formed from any metadata information related to the media file. The group may be created automatically by the media diary application or by the request of a user.

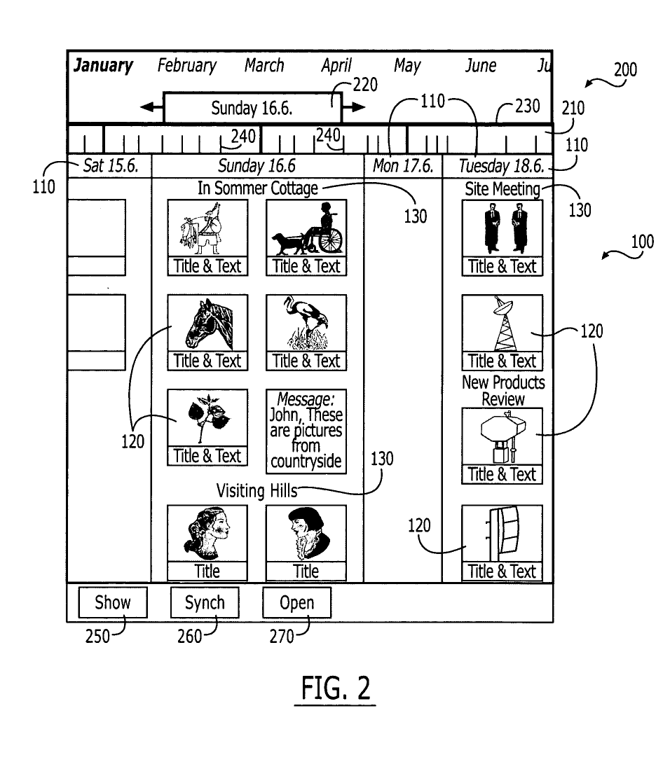

The media diary will typically incorporate a function that provides for ease in communicating a media file to another network communication device. For example, the media diary may include a send file function (not shown in FIG. 2) that invokes an email application, SMS application, MMS application or other file transfer application. Media files are typically highlighted and added to the email, SMS or MMS as an attachment or otherwise communicated to the designated communication device.

The width of the date columns 110 in the media view 100 may dynamically and/or automatically vary based upon the number of media file representations in the column, size of the media file icons or thumbnails or the user's preference for formatting the media file representations. For example, if a first date column incorporates three times the number of media file representations as the second date column, then the first date column will likely be three times as wide as the second date column, i.e., the widths of the columns may be allocated in proportion to the number of media file representations within the respective column. Alternatively, the user may dictate or fix the width of a date column or the size of the thumbnail images may dictate the width of the date columns. In addition, the media view may be incorporated with a function that provides for condensing the media view to only those dates that have media files associated therewith.

The media view may also incorporate other functions that aid in finding data files within the media view. For example, the media view may include a condensed view function (not shown in FIG. 2) that allows the user to condense the media file representations, such that the width of the date columns decreases and the amount of representations visible on the display increases. In addition, the media view may include a search function (not shown in FIG. 2) that allows the user to search for a key word, moment of time or phrase that exists in the digital file metadata and/or the calendar event information file. The results of the search function provide access to only those media files associated with the searched word, time or phrase. In the same regard, the media view may include a filter function (not shown in FIG. 2) that allows the user to filter the media that is shown according to media type, such as image files, video files, audio files, text files or the like or to filter by dates that incorporate media files.

Additionally, the media view may incorporate a note function (not shown in FIG. 2) that allows the media diary user to add notes for a specific moment of time, such as a date and/or time. The note function will access a notepad that allows the user to write an appropriate note. The note will then be added to the media view on the specific media files, moment of time or period of time intended. It should apparent that the note function differs from text files that are received by the user via email, text messaging or some other form of digital communication, or from text documents, images or presentations created by the user of the device.

In addition, the media view may provide for a zoom function. The zoom function will allow the user of the media diary to zoom in or zoom out of the media view, as the application dictates. For example, zooming in on a particular portion of the media view will display the media file representations in greater detail; thus, providing the user better recognition of the media file that is being represented. Zooming out on a particular portion of the media view will display more media file representations; thus, providing the user insight into the overall quantity and type of media files that are associated with the time period displayed in the media view.

FIG. 2 illustrates an example of a timeline view 200 that is presented in combination with the media view 100 and provides access to the digital media files according to periods of time in the timeline, in accordance with an embodiment of the present invention. As depicted, the media view 100 is displayed below the timeline view; however, in alternate embodiments the timeline view may be presented below the media view or the right of left of the media view. The timeline view will be generated by the second computer-readable program instructions as implemented in association with a digital device. It is noted that the timeline view herein depicted and described is by way of example only; other timeline views that provide for the display of a timeline in combination with a media view and a calendar view are also contemplated and within the inventive concepts herein disclosed.

The timeline view 200 of the illustrated embodiment provides for a time bar 210 and a time handle 220. The time handle allows the media diary to be scrolled forward in time and backward in time. The time handle is associated with the center most column, that is, in the depicted example, the column associated with the date, Tuesday 18, June. If the time handle is moved from the stationary position to the left, the media view and, in some instances the time bar will scroll to the right, such that, more past dates in the media view will be scrolled and displayed. If the time handle is moved from the stationary position to the right, the media view and, in some instances the time bar, will scroll to the left, such that, more future dates in the media view will be scrolled and displayed. The stationary position is usually in the centerline of the media diary display, or in the centerline of the time bar, or, alternatively, in the centerline of the media view. For a more detailed description of the functionality of the time handle, see co-pending U.S. patent application Ser. No. 10/715,095, entitled, “Speed Browsing of Media Items in a Media Diary”, filed on Nov. 17, 2003, in the name of inventors Lindholm et al., and assigned to the same assignee as the present invention. That application is herein incorporated by reference as if setforth fully herein.

The time bar 210 allows the device user to focus in on specific dates. In the example shown, the bold cased blocks 230 may indicate weeks and the individual vertical lines 240 within the blocks may indicate ranges for specific dates on which media files currently exist. A space between the ranges indicates the amount of media files associated or stored on a specific date. Different days may be graphically altered, e.g. by different shading and/or color, to distinguish them from each other. For example, every second day may have dark shading and every third day may have light shading. Different weeks may also be graphically altered, e.g. by different shading and/or color, to distinguish them from each other.

Alternatively, shading or differently coloring within the time bar may indicate dates on which media files exist. For example, dark shading within the time bar may indicate that files exist on those dates, while light shading within the time bar may indicate that no files exist on those dates. In addition, the length of the shading may indicate the volume of media files that exist on a specific date. For example, lengthy shading that produces a relatively thick mark may indicate voluminous media files exist on the date, while a shaded hash mark may indicate that only one file exists on that date. For a more detailed description of the functionality of the time bar, see co-pending U.S. patent application Ser. No. 10/715,162, entitled, “Time Bar Navigation in Media Diary Application”, filed on Nov. 17, 2003, in the name of inventors Myka et al., and assigned to the same assignee as the present invention. That application is herein incorporated by reference as if setforth fully herein.

In addition, to the time bar and time handle features the timeline view may incorporate other functions. As shown, the timeline view may include a show key 250 that provides the user a presentation mode for a specified media file. For example, if a highlighted media file includes more than one image, engaging the show key will provide the user a slide show presentation of all the images in the file. Alternatively, the show key may provide a user a presentation mode for a specified media file or media files under a specific event or subject, or under a specific day or time period. The timeline view may include a synch key 260 that provides the digital device with a means of creating communication synchronization with other digital communication devices in the immediate area that implement a media diary application. The open key 270 provides for the selected or highlighted media file to be opened and displayed in detailed form, typically encompassing the entire display.

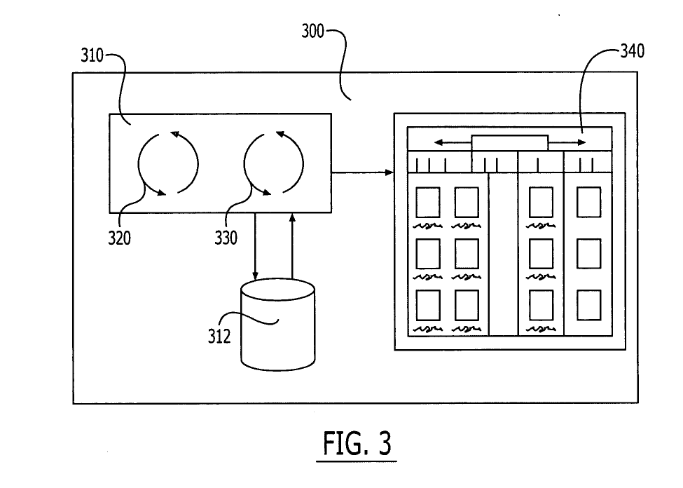

A further embodiment of the invention is defined by a digital device that implements the media diary, in accordance with an embodiment of the present invention. FIG. 3 illustrates a block diagram of digital device 300 that implements the media diary. As previously noted, the digital device will typically be a digital device capable of digital communication with other digital devices, such as a mobile terminal including for example, a mobile telephone, a PDA, laptop computer or the like. However, the digital device may be any other device capable of displaying the media diary of the present invention such as a digital camera, digital video recorder, digital audio recorder or the like.

The digital device 300 will include a processing unit 310, such as a processor, an application specific integrated circuit, analog and/or digital circuitry, or any other similar device that executes computer-readable program instructions for accessing media files. Wherein the program instructions and the media files are generally stored in memory device 312. The computer-readable program instructions will include first instructions 320 for generating a media view that provides access to digital media files and associates digital media files with a period of time, and second instructions 330 for generating a timeline view that is presented in combination with the media view and provides access to the digital media files according to periods of time in the timeline. In addition, the digital device will include, or may be in external communication with, a display 340 that is in communication with the processing unit and provides a presentation mechanism for the media view and the timeline view.

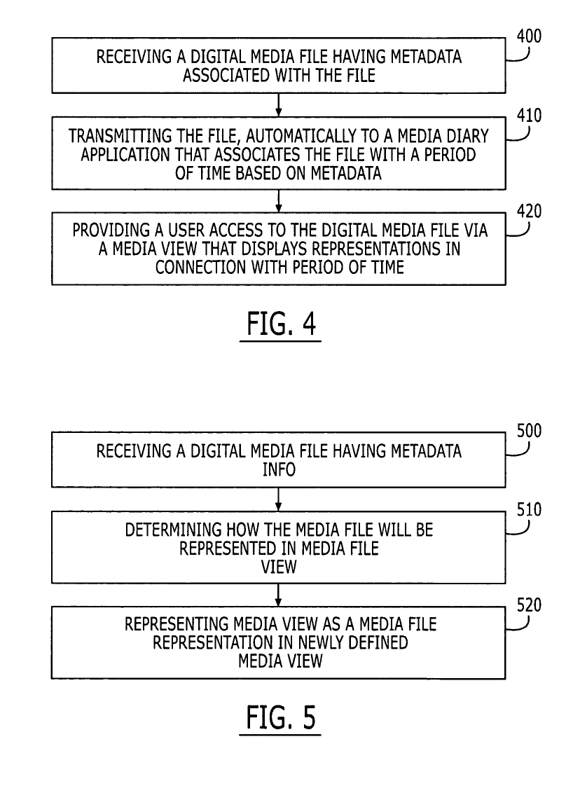

The present invention is also embodied in methods for digital media management in a digital device. FIG. 4 presents a flow diagram of such a method, in accordance with an embodiment of the present invention. At step 400, the digital device receives a digital media file having associated metadata information. Typically, the digital device will either receive the digital file from an internal digital device, such as a camera, video recorder or the like, or receive the digital file from a secondary digital device, such as a digital camera, digital camcorder or the like, that is in digital communication with the digital device. For example, a mobile telephone equipped with a camera may communicate with another remote mobile telephone, PDA, PC or the like, and transfer the images from the camera to the remote device. Or, for example, a mobile telephone may communicate with an external digital camera via short-range communication means, and first transfer the images from the camera to the mobile telephone and subsequently to another digital device. In addition, it is possible for the digital device to receive the digital files by memory transfer via portable memory devices. The metadata information associated with the file identifies the file and provides for a timestamp and other information. The metadata will typically be automatically created at the time the media file is created or manually inputted at or near the time the media file is created or received.

At step 410, the digital device will transmit the file, typically automatically, to a media diary application that associates the digital media file with a period of time based on the metadata of the media file. By providing for automatic transmission of a received media file to the media diary, the user of the digital device does have to manually input the media file into the diary. However, manual input is contemplated and within the inventive concepts herein disclosed. At step 420, the user of the digital device is provided access to the digital media file via a media view that displays a representation of the digital media file in connection with a period of time. Optionally, the user may be provided the ability to locate the digital media files within the media view by scrolling a timeline that is displayed in conjunction with the media view.

The invention may also be defined by a method for defining media file representations in a media diary, in accordance with another aspect of the invention, as shown in FIG. 5. At step 500, a digital device receives a digital media file having metadata information. As previously noted, the digital file will typically be received from internal sources or from other devices in network communication with the device. The metadata information may be automatically inserted into the file at the time of recordation and/or it may be manually inserted by the device user. At step 510, a determination is made as to a manner in which the media file will be represented in a media view. This will entail determination of at least one parameter chosen from the group consisting of, size of the icon, image or thumbnail representing the media file, size of the title or text describing the media file, size of the date column, size of the media file, size of the timeline view and resolution of the display. At step 520, media file is represented as a media file representation in a combined media view and timeline view presentation according to the determined manner of representation.

The described embodiments of the present invention provide for a media file management application for a digital device that storage and provide access to of media files according to an associated moment or period of time, such as a date. The media file management application is capable of automatically entering received media files into the application and automatically associating the media file with a specific moment or period of time, such as a date or event. The invention provides efficiency to the user, in that, the media view and the timeline view combine to provide an application that is highly searchable for the purpose of making the media files readily accessed by the user. In addition, the media file management application provides the capability to easily further disseminate the media files to other digital communication devices. In addition, the media file management application provides the capability to easily represent the media files to the user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An application for providing access to media files on a digital device, the application comprising a computer readable storage medium having computer-readable program instructions embodied in the medium, the computer-readable program instructions comprising:
first instructions for generating a media view that provides access to at least one digital media file and associates the at least one digital media files with a period of time; and
second instructions for generating a timeline view that is presented in combination with the media view and provides access to the at least one digital media file according to periods of time defined in the timeline.

2. The application of claim 1, wherein the first instructions for generating the media view further associates the at least one digital media file with event information.

3. The application of claim 2, wherein the second instructions for generating a timeline view further provides access to the at least one digital media file according to events in the timeline.

4. The application of claim 1, wherein the first instructions associates the least one digital media file with a period of time that is defined by metadata associated with the at least one digital media file

5. The application of claim 1, wherein the first instructions further includes instructions for generating title information for the at least one digital media file.

6. The application of claim 5, wherein the first instructions for generating title information further includes instructions for displaying, in the media view, the title information in conjunction with the at least one digital media file.

7. The application of claim 5, wherein the first instructions for generating title information for the at least one digital media file defines the title information by metadata associated with the at least one media file.

8. The application of claim 1, wherein the first instructions further includes instructions for generating group title information for a plurality of digital media files having related metadata information.

9. The application of claim 8, wherein the first instructions for generating group title information further includes instructions for displaying, in the media view, the group title information in conjunction with the plurality of digital media files.

10. The application of claim 8, wherein the first instructions for generating group title information for the plurality of digital media files defines the group title information by comparable metadata associated with the plurality of digital media files.

11. The application of claim 1, wherein the second instructions for generating the timeline view further provides for instructions for generating a scrollable timeline that provides for locating periods of time by scrolling the timeline.

12. The application of claim 11, wherein the second instructions for generating the timeline view further provides for generating a scrollable timeline that is scrollable in a horizontal manner.

13. The application of claim 11, wherein the second instructions for generating the timeline view further provides for generating a scrollable timeline that is scrollable in a vertical manner.

14. The application of claim 1, wherein the first instructions for generating the media view further provides for instructions for generating a scrollable media view for locating media files by scrolling the media view.

15. The application of claim 14, wherein the first instructions for generating the media view further provides for generating a scrollable media view that is scrollable in a horizontal manner.

16. The application of claim 14, wherein the first instructions for generating the media view further provides for generating a scrollable media view that is scrollable in a vertical manner.

17. The application of claim 1, wherein the first instructions for generating the media view and the second instructions for generating a timeline view further provide for instructions for generating a scrollable media view and a scrollable timeline view that provide for locating one or more media files by scrolling,

18. The application of claim 17, wherein the first instructions for generating the media view and the second instructions for generating a timeline view further provide for instructions for scrolling the media view in a horizontal manner and scrolling the timeline view in a horizontal manner.

19. The application of claim 17, wherein the first instructions for generating the media view and the second instructions for generating a timeline view further provide for instructions for scrolling the media view in a vertical manner and scrolling the timeline view in a vertical manner.

20. The application of claim 1, wherein the second instructions for generating a timeline view further provides for instructions for generating a timeline in the form of a time bar.

21. The application of claim 1, wherein the second instructions for generating a timeline view further provides for instructions for generating a time handle that provides for the timeline to be scrolled.

22. The application of claim 1, further comprising third instructions for searching the media view in terms of a period of time.

23. The application of claim 1, further comprising third instructions for searching the media view in terms of any combination of metadata information.

24. The application of claim 1, wherein the first instructions for generating a media view further provides for instructions for adjusting the area of the periods of time within the media view according to the amount of digital media files in the period of time.

25. The application of claim 24, wherein the first instructions for adjusting the area of the periods of time further comprises adjusting the area of the period of time view so that all of the media files within a period of time are viewable within a display.

26. A method for digital media management in a digital device, the method comprising the steps of:
receiving, at the digital device, a digital media file having metadata associated with the digital media file;
transmitting the file to a media diary application that associates the digital media file with a period in time based on the metadata; and
providing a user access to the digital media file via a media view that displays a representation of the digital media file in connection with the period of time.

27. The method of claim 26, further comprising the step of providing the user the ability to locate digital media files within the media view by scrolling a timeline that is displayed in conjunction with the media view.

28. The method of claim 26, further comprising the step of providing a user the ability to locate digital media files within the media view by movement of a time handle that is displayed in conjunction with the media view.

29. A method for defining media file representation in a media view of a media diary application, the method comprising the steps of:
receiving a media file having associated metadata information;
determining a manner in which the media file will be represented in a media view of the media diary;
presenting the media file as a media file representation in the media view in accordance with the determination of the manner of representation.

30. The method of claim 29, wherein the step of determining the manner in which the media file will be represented in a media view of the media diary further comprises determining the size of a thumbnail representing the media file.

31. The method of claim 29, wherein the step of determining the manner in which the media file will be represented in a media view of the media diary further comprises determining the size of the date column that the representation will reside in.

32. The method of claim 29, wherein the step of determining the manner in which the media file will be represented in a media view of the media diary further comprises determining the size of the media view in proportion to the overall viewing area.

33. The method of claim 29, wherein the step of determining the manner in which the media file will be represented in a media view of the media diary further comprises determining a quantity of the media files represented in a date column.

34. The method of claim 29, further comprising the step of providing the user the ability to locate a media file within the media view by scrolling the media view.

35. A digital device, the device comprising:
a processing unit that executes computer-readable program instructions for accessing media files, the computer-readable program instructions comprising:
first instructions for generating a media view that provides access to at least one digital media file and associates the at least one digital media files with a period of time,
second instructions for generating a timeline view that is presented in combination with the media view and provides access to the at least one digital media file according to periods of time defined in the timeline; and
a display in communication with the processing unit that presents, independently, the media view and the timeline view.
